(19) United States
(12) Patent Application Publication
(10) Pub. No.: US 2026/0355837 A1
(43) Pub. Date: Nov. 12, 2026

(54) SUBSTRATE POLISHING APPARATUS

(71) Applicant: Samsung Electronics Co., Ltd., Suwon-si (KR)

(72) Inventors: Donghoon Kwon, Suwon-si (KR); Boun Yoon, Suwon-si (KR)

(73) Assignee: Samsung Electronics Co., Ltd., Suwon-si (KR)

(21) Appl. No.: 19/670,144

(22) Filed: May 7, 2026

(30) Foreign Application Priority Data
May 12, 2025 (KR) 10-2025-0061465

(51) Int. Cl. B23H 5/10; B23H 3/02; B23H 5/08

(52) U.S. Cl. CPC B23H 5/10; B23H 3/02; B23H 5/08

(57) ABSTRACT

A substrate polishing apparatus includes a process chamber, a substrate support located in the process chamber and configured such that a substrate is mounted thereon, a lower electrode located on the substrate support and located below the substrate, a plurality of upper electrodes located above the substrate support and separated from one another in a substantially horizontal direction, and a power supply source configured to apply voltages to the plurality of upper electrodes and the lower electrode, wherein the plurality of upper electrodes include a plurality of edge upper electrodes and a plurality of center upper electrodes, a width of each of the plurality of upper electrodes is less than a width of the lower electrode, and a portion of each of the plurality of edge upper electrodes protrudes outwardly from the substrate support in the plan view.

### CROSS-REFERENCE TO RELATED APPLICATIONS

This present application claims priority to and the benefit under 35 U.S.C. § 119(a)-(d) of Korean Patent Application No. 10-2025-0061465, filed on May 12, 2025, in the Korean Intellectual Property Office, the entire disclosure of which is incorporated herein by reference.

### FIELD

The disclosed concepts relate to a substrate polishing apparatus, and more particularly, to a substrate polishing apparatus for performing an electrochemical polishing process.

### BACKGROUND

In the semiconductor industry, the continuous miniaturization of semiconductor chips has greatly increased the demand for precision in polishing processes. In the manufacture of microstructures of semiconductor chips, mechanical polishing methods have limitations due to physical contact, and electrochemical polishing processes have gained attention to overcome this issue. Continuous research has been conducted in various fields to optimize electrochemical polishing processes.

### SUMMARY

The disclosed concepts provide a substrate polishing apparatus having improved polishing precision.

According to aspects of the disclosed concepts, there is provided a substrate polishing apparatus including a process chamber providing a processing space, a substrate support located in the processing space of the process chamber and configured such that a substrate is mounted thereon, a lower electrode located on the substrate support and located below the substrate, a plurality of upper electrodes located in the processing space, separated from the substrate support, located above the substrate support, and separated from one another in a substantially horizontal direction, and a power supply source configured to apply voltages to the plurality of upper electrodes and the lower electrode, wherein the plurality of upper electrodes include a plurality of edge upper electrodes and a plurality of center upper electrodes, the plurality of edge upper electrodes being located outermost among the plurality of upper electrodes in a plan view, and the plurality of center upper electrodes being located in a region surrounded by the plurality of edge upper electrodes, a width of each of the plurality of upper electrodes is less than a width of the lower electrode, and a portion of each of the plurality of edge upper electrodes protrudes outwardly from the substrate support in the plan view.

According to aspects of the disclosed concepts, there is provided a substrate polishing apparatus including a process chamber providing a processing space, a substrate support located in the processing space of the process chamber and configured such that a substrate is mounted thereon, a lower electrode located on the substrate support and located below the substrate, a plurality of upper electrodes located in the processing space, separated from the substrate support, located above the substrate support, and separated from one another in a substantially horizontal direction, an electrolyte located in the processing space of the process chamber and located between the plurality of upper electrodes and the lower electrode, a power supply source configured to apply voltages to the plurality of upper electrodes and the lower electrode, and a plurality of variable resistors respectively connected to the plurality of upper electrodes.

According to aspects of the disclosed concepts, there is provided a substrate polishing apparatus including a process chamber providing a processing space, a substrate support located in the processing space of the process chamber and configured such that a substrate is mounted thereon, a lower electrode located on the substrate support and located below the substrate, a plurality of upper electrodes located in the processing space, separated from the substrate support, located above the substrate support, and separated from one another in a substantially horizontal direction, a power supply source configured to apply voltages to the plurality of upper electrodes and the lower electrode, a plurality of variable resistors respectively connected to the plurality of upper electrodes, and a plurality of feedback units respectively connected to the plurality of upper electrodes and the plurality of variable resistors and configured to measure amounts of current flowing to the respective plurality of upper electrodes and adjust resistance values of the respective plurality of variable resistors, wherein the plurality of upper electrodes include a plurality of edge upper electrodes and a plurality of center upper electrodes, the plurality of edge upper electrodes being located outermost among the plurality of upper electrodes in a plan view, and the plurality of center upper electrodes being located in a region surrounded by the plurality of edge upper electrodes, a width of each of the plurality of upper electrodes is less than a width of the lower electrode, and lower surfaces of the plurality of edge upper electrodes overlap a side surface of the substrate support in a substantially vertical direction.

According to aspects of the disclosed concepts, there is provided a method of polishing a substrate by using a substrate polishing apparatus including a plurality of upper electrodes, the method including mounting the substrate on a substrate support, applying, by a power supply source, voltages to the plurality of upper electrodes and a lower electrode located below the substrate, and removing the polished substrate from the substrate polishing apparatus.

In some embodiments, the method may further include, after the mounting of the substrate on the substrate support, filling an electrolyte inside a process chamber of the substrate polishing apparatus, wherein a vertical level of an upper surface of the electrolyte may be lower than a vertical level of upper surfaces of the plurality of upper electrodes and higher than a vertical level of lower surfaces of the plurality of upper electrodes.

In some embodiments, in the applying, by the power supply source, of the voltages to the plurality of upper electrodes and the lower electrode, a portion of a metal pattern of the substrate may be dissolved in the electrolyte.

In some embodiments, in the applying, by the power supply source, of the voltages to the plurality of upper electrodes and the lower electrode, the plurality of upper electrodes may become cathodes, and the metal pattern of the substrate may become an anode.

In some embodiments, in the mounting of the substrate on the substrate support, the substrate may be mounted on the substrate support such that a lower surface of each of a plurality of edge upper electrodes of the plurality of upper electrodes overlaps a side surface of the substrate in a substantially vertical direction.

In some embodiments, in the mounting of the substrate on the substrate support, the plurality of upper electrodes may be located above the substrate and be separated from the substrate, and the substrate may be electrically connected to the lower electrode.

In some embodiments, the substrate polishing apparatus may further include a plurality of variable resistors respectively connected to the plurality of upper electrodes.

In some embodiments, the substrate polishing apparatus may further include a plurality of feedback units configured to measure amounts of current flowing to the respective plurality of upper electrodes and to adjust resistance values of the respective plurality of variable resistors.

In some embodiments, in the applying, by the power supply source, of the voltages to the plurality of upper electrodes and the lower electrode, each of the above plurality of feedback units may control a substrate polishing speed.

In some embodiments, in the applying, by the power supply source, of the voltages to the plurality of upper electrodes and the lower electrode, the plurality of feedback units may measure changes in the amounts of current flowing to the respective plurality of upper electrodes.

### BRIEF DESCRIPTION OF THE DRAWINGS

Embodiments will be more clearly understood from the following detailed description taken in conjunction with the accompanying drawings in which:

FIG. 1 is a schematic cross-sectional view of a substrate polishing apparatus according to some embodiments;

FIG. 2 is a schematic cross-sectional view of region EX of the substrate polishing apparatus of FIG. 1;

FIG. 3 is a schematic plan view of a substrate polishing apparatus according to some embodiments;

FIG. 4 is a schematic plan view of a substrate polishing apparatus according to some embodiments;

FIG. 5 is a schematic plan view of a substrate polishing apparatus according to some embodiments;

FIG. 6 is a schematic plan view of a substrate polishing apparatus according to some embodiments;

FIG. 7 is a schematic plan view of a substrate polishing apparatus according to some embodiments;

FIG. 8 is a schematic plan view of a substrate polishing apparatus according to some embodiments;

FIG. 9 is a schematic plan view of a substrate polishing apparatus according to some embodiments;

FIG. 10 is a schematic plan view of a substrate polishing apparatus according to some embodiments;

FIG. 11 is a schematic plan view of a substrate polishing apparatus according to some embodiments;

FIG. 12 is a schematic plan view of a substrate polishing apparatus according to some embodiments;

FIG. 13 is a schematic cross-sectional view of a substrate polishing apparatus according to some embodiments;

FIG. 14 is a schematic cross-sectional view of a substrate polishing apparatus according to some embodiments; and

FIG. 15 is a schematic cross-sectional view of a substrate polishing apparatus according to some embodiments.

### DETAILED DESCRIPTION

Embodiments are provided to fully explain the disclosed concepts to those of ordinary skill in the art. The following embodiments may be modified in many different forms, and the scope of the disclosed concepts is not limited to the following embodiments. Rather, these embodiments are provided so that the disclosed concepts will be thorough and complete, and will fully convey the spirit of the disclosed concepts to those of ordinary skill in the art.

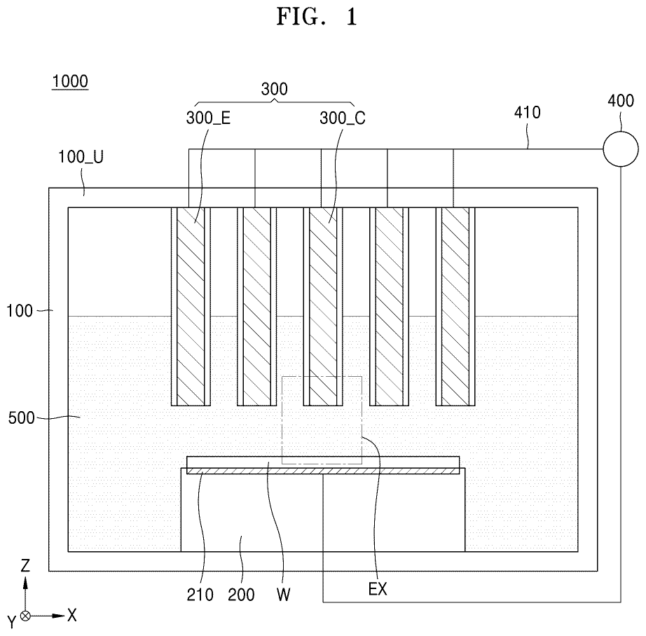

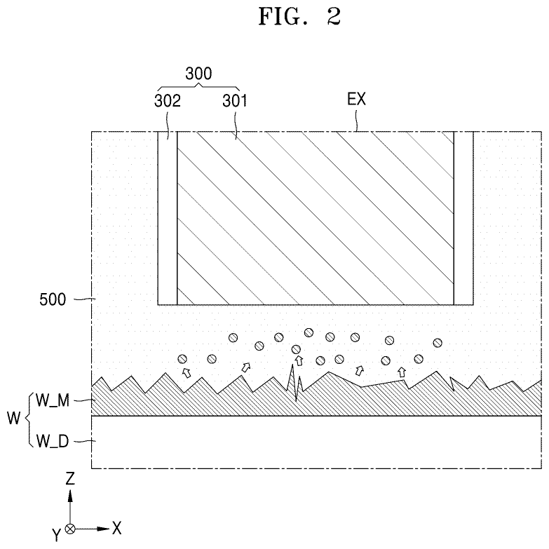

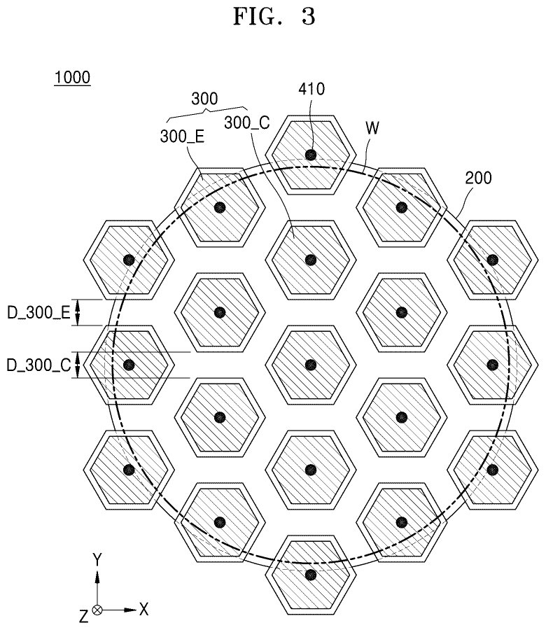

FIG. 1 is a schematic cross-sectional view of a substrate polishing apparatus 1000 according to some embodiments. FIG. 2 is a schematic cross-sectional view of region EX of the substrate polishing apparatus 1000 of FIG. 1. FIG. 3 is a schematic plan view of the substrate polishing apparatus 1000 according to some embodiments.

Herein, unless particularly defined otherwise, a direction parallel to a bottom surface of a process chamber 100 is defined as a first horizontal direction (X direction), a direction perpendicular to the bottom surface of the process chamber 100 is defined as a vertical direction (Z direction), and a direction perpendicular to the first horizontal direction (X direction) and the vertical direction (Z direction) is defined as a second horizontal direction (Y direction). A direction combining the first horizontal direction (X direction) and the second horizontal direction (Y direction) is defined as a horizontal direction.

Referring to FIGS. 1 to 3, the substrate polishing apparatus 1000 may include the process chamber 100, a substrate support 200, a lower electrode 210, a plurality of upper electrodes 300, and a power supply source 400. The substrate polishing apparatus 1000 may perform an electrochemical polishing (ECP) process. For example, the substrate polishing apparatus 1000 may perform an ECP process to remove a portion of a metal pattern W_M of a substrate W by using an electric field.

The process chamber 100 may provide a processing space in which a polishing process of the substrate W to be polished is performed. For example, the process chamber 100 may have a cylindrical shape with a processing space formed therein. For example, the processing space may be sealed from the outside of the process chamber 100 by an inner wall of the process chamber 100.

Although not specifically illustrated, the process chamber 100 may include a supply hole configured to allow an electrolyte 500 to flow into the processing space of the process chamber 100, and a discharge hole configured to discharge the electrolyte 500 located inside the processing space to the outside. For example, the supply hole may be connected to an electrolyte storage tank, and the discharge hole may be connected to a pump. In some embodiments, the process chamber 100 may include, in a side wall thereof, a groove configured to allow the substrate W to be brought into and taken out of the processing space.

The substrate support 200 may be located inside the process chamber 100. For example, the substrate support 200 may be provided in the processing space of the process chamber 100. For example, the substrate support 200 may be installed on the bottom of the process chamber 100.

The substrate support 200 may be configured to support the substrate W to be polished. The substrate support 200 may support the substrate W such that an upper surface of the substrate W faces a ceiling 100_U of the process chamber 100 and a lower surface of the substrate W faces the bottom of the process chamber 100. For example, the area of an upper surface of the substrate support 200 may be greater than the area of the upper surface of the substrate W.

In some embodiments, the substrate support 200 may have a shape corresponding to the substrate W, for example, a disk shape. The substrate support 200 may include, for example, a metal material or a ceramic material. In some embodiments, the substrate support 200 may be an electrostatic chuck that supports the substrate W with electrostatic force, or a vacuum chuck that supports the substrate W with negative pressure. In some embodiments, a support pin (not shown) may be located on the upper surface of the substrate support 200. The substrate support 200 may support the substrate W through the support pin that is in contact with the lower surface of the substrate W.

In some embodiments, the lower electrode 210 may be located on the substrate support 200, and may be located below the substrate W. The lower electrode 210 may be located inside the substrate support 200, or may be located on the upper surface of the substrate support 200. For example, an upper surface of the lower electrode 210 may be exposed to the outside with respect to the substrate support 200. For example, the area of the upper surface of the lower electrode 210 may be greater than or equal to the area of the upper surface of the substrate W. However, embodiments are not limited thereto, and the area of the upper surface of the lower electrode 210 may be less than the area of the upper surface of the substrate W.

The lower electrode 210 may be electrically connected to the power supply source 400, and the power supply source 400 may apply a voltage to the lower electrode 210. The lower electrode 210 may be located at an upper end of the substrate support 200.

In some embodiments, the lower electrode 210 may be in direct contact with the metal pattern W_M of the substrate W, and thus, when a voltage is applied to the lower electrode 210, the voltage may be applied to the metal pattern W_M of the substrate W.

In some embodiments, even without the lower electrode 210 being in direct contact with the metal pattern W_M of the substrate W, when a voltage is applied to the lower electrode 210, the voltage may be coupled to the substrate W. For example, when a positive voltage is applied to the lower electrode 210 by the power supply source 400, the positive voltage may be coupled to the substrate W.

The plurality of upper electrodes 300 may be located in the processing space of the process chamber 100. The plurality of upper electrodes 300 may be attached to the ceiling 100_U of the process chamber 100. The plurality of upper electrodes 300 may be separated from the substrate support 200 in the vertical direction (Z direction), and may be located above the substrate support 200. The plurality of upper electrodes 300 may not be in contact with the substrate W mounted on the substrate support 200. For example, the metal pattern W_M of the substrate W to be polished may be polished without physical contact.

Each of the plurality of upper electrodes 300 may be electrically connected to the power supply source 400. The plurality of upper electrodes 300 may be connected in parallel to the power supply source 400. For example, a voltage applied to the plurality of upper electrodes 300 and a voltage applied to the lower electrode 210 may be opposite to one another. For example, a negative voltage may be applied to the plurality of upper electrodes 300, and a positive voltage may be applied to the lower electrode 210.

For example, in a substrate polishing process, the plurality of upper electrodes 300 may act as cathodes, and the metal pattern W_M of the substrate W, to which a voltage is applied by the lower electrode 210, may act as an anode.

Although FIG. 1 shows that one power supply source 400 applies a voltage to the plurality of upper electrodes 300 and the lower electrode 210, the number of power supply sources is not limited thereto.

In some embodiments, each of the plurality of upper electrodes 300 may include a core 301 and a housing 302 surrounding a side surface of the core 301. The housing 302 may protect the side surface of the core 301 to prevent the core 301 from being corroded by the electrolyte 500. In some embodiments, a lower surface of the core 301 may be exposed to the outside with respect to the housing 302. For example, the lower surface of the core 301 may be in contact with the electrolyte 500. For example, the core 301 may include a conductive material, and the housing 302 may include an insulating material.

In some embodiments, a wire 410 may connect the power supply source 400 to each of the plurality of upper electrodes 300. The wire 410 may connect the power supply source 400 to the lower electrode 210. For example, the wire 410 may be connected to the core 301 of each of the plurality of upper electrodes 300. For example, the wire 410 may be located inside the substrate support 200. In some embodiments, one wire 410 may be connected to the core 301 of each of the plurality of upper electrodes 300.

The arrangement of the plurality of upper electrodes 300 will be described in detail with reference to FIG. 3. Hereinafter, the plurality of upper electrodes 300 will be described with respect to a plan view.

The plurality of upper electrodes 300 may be separated from one another in the horizontal direction. The plurality of upper electrodes 300 may be arranged to form a circle. For example, the plurality of upper electrodes 300 may be arranged according to the shape of the substrate W.

In some embodiments, the plurality of upper electrodes 300 may be arranged in a concentric pattern. For example, as shown in FIG. 3, the plurality of upper electrodes 300 may be arranged in three concentric circles. However, the number of concentric circles formed by the plurality of upper electrodes 300 is not limited thereto.

In some embodiments, the plurality of upper electrodes 300 may be separated from one another at equal intervals. For example, separation distances between adjacent upper electrodes among the plurality of upper electrodes 300 may be the same. For example, a second distance D_300_C, which is a separation distance between a plurality of center upper electrodes 300_C, may be substantially equal to a first distance D_300_E, which is a separation distance between a plurality of edge upper electrodes 300_E.

In some embodiments, an air gap may be formed between the plurality of upper electrodes 300. For example, when the electrolyte 500 is filled in the processing space of the process chamber 100, air and the electrolyte 500 may be located in a separation space between the plurality of upper electrodes 300. For example, the plurality of upper electrodes 300 may be separated from one another with an air gap therebetween, and thus, the occurrence of noise between the plurality of upper electrodes 300 may be suppressed.

In some embodiments, a lower surface of each of the plurality of upper electrodes 300 may be have a hexagonal shape. For example, the plurality of upper electrodes 300 having hexagonal lower surfaces may be easily manufactured and arranged in a circular shape. However, embodiments are not limited thereto, and the plurality of upper electrodes 300 may each have a polygonal shape.

The widths of the plurality of upper electrodes 300 may be the same. For example, the areas of the lower surfaces of the plurality of upper electrodes 300 may all be the same. In some embodiments, the width of each of the plurality of upper electrodes 300 may be less than the width of the lower electrode 210. For example, the width of each of the plurality of upper electrodes 300 may be less than the width of the substrate W. For example, the area of the lower surface of each of the plurality of upper electrodes 300 may be less than the area of the upper surface of the substrate W. For example, the width of one of the plurality of upper electrodes 300 may be less than the width of the substrate W.

The plurality of upper electrodes 300 may include the plurality of edge upper electrodes 300_E and the plurality of center upper electrodes 300_C. The plurality of edge upper electrodes 300_E may refer to upper electrodes that are located outermost among the plurality of upper electrodes 300.

For example, when the plurality of upper electrodes 300 are arranged in a concentric pattern, the plurality of edge upper electrodes 300_E may refer to upper electrodes arranged on the outermost circle in the concentric pattern.

The plurality of center upper electrodes 300_C may refer to upper electrodes located in an internal region defined by the arrangement of the plurality of edge upper electrodes 300_E. The plurality of center upper electrodes 300_C may be located in a region surrounded by the plurality of edge upper electrodes 300_E.

For example, when the plurality of upper electrodes 300 are arranged in a concentric pattern, the plurality of center upper electrodes 300_C may refer to upper electrodes arranged on a circle other than the outermost circle in the concentric pattern.

In some embodiments, the plurality of edge upper electrodes 300_E may form an electric field in an edge region of the substrate W, and the plurality of center upper electrodes 300_C may form an electric field in a central region of the substrate W. For example, the plurality of edge upper electrodes 300_E may polish the metal pattern W_M located in the edge region of the substrate W, and the plurality of center upper electrodes 300_C may polish the metal pattern W_M located in the central region of the substrate W.

Portions of the plurality of edge upper electrodes 300_E may protrude outwardly from the substrate support 200. For example, the plurality of edge upper electrodes 300_E may overlap a side surface of the substrate support 200 in the vertical direction (Z direction). For example, the plurality of edge upper electrodes 300_E may protrude outwardly from the substrate W. For example, the center of a lower surface of each of the plurality of edge upper electrodes 300_E may overlap the edge of the upper surface of the substrate W in the vertical direction (Z direction). For example, the plurality of edge upper electrodes 300_E may overlap the edge region of the substrate W in the vertical direction (Z direction).

The plurality of center upper electrodes 300_C may overlap the upper surface of the substrate support 200 in the vertical direction (Z direction). For example, the entire lower surfaces of the plurality of center upper electrodes 300_C may face the upper surface of the substrate support 200. For example, the entire lower surfaces of the plurality of center upper electrodes 300_C may face the upper surface of the substrate W.

In some embodiments, the area of a region of the upper surface of the substrate W that overlaps the plurality of upper electrodes 300 in the vertical direction (Z direction) may be greater than the area of a region of the upper surface of the substrate W that does not overlap the plurality of upper electrodes 300 in the vertical direction (Z direction).

Referring again to FIG. 1, the substrate polishing apparatus 1000 may further include the electrolyte 500. The electrolyte 500 may fill the processing space of the process chamber 100. In some embodiments, the electrolyte 500 may be in a liquid state. The electrolyte 500 may be located between the plurality of upper electrodes 300 and the lower electrode 210. The substrate support 200 and the substrate W mounted on the substrate support 200 may be located inside the electrolyte 500. The lower surfaces and side surfaces of the plurality of upper electrodes 300 may be located inside the electrolyte 500.

For example, the electrolyte 500 may be filled in the processing space of the process chamber 100 such that the lower surfaces of the plurality of upper electrodes 300 are immersed in the electrolyte 500. For example, a vertical level of an upper surface of the electrolyte 500 may be higher than a vertical level of the lower surfaces of the plurality of upper electrodes 300 and lower than a vertical level of upper surfaces of the plurality of upper electrodes 300. The electrolyte 500 may be located between the plurality of upper electrodes 300.

The electrolyte 500 may act as a medium between the plurality of upper electrodes 300 and the substrate W. For example, when a voltage is applied to each of the plurality of upper electrodes 300 and the substrate W, charges may move through the electrolyte 500, and thus, a substrate polishing process may be performed. For example, the electrolyte 500 may include an acidic material, such as phosphoric acid, sulfuric acid, or nitric acid, and a salt material, such as copper sulfate, copper chloride, or copper nitrate.

A substrate polishing process will be described in detail with reference to FIG. 2.

The substrate W to be polished may include a base layer W_D and the metal pattern W_M deposited on the base layer W_D. When the metal pattern W_M is formed through a deposition process such as an electrolytic plating process on the base layer W_D, an upper surface of the metal pattern W_M may be curved.

The power supply source 400 may apply a voltage to each of the plurality of upper electrodes 300 and the lower electrode 210. The power supply source 400 may apply a negative voltage to the plurality of upper electrodes 300, and may apply a positive voltage to the lower electrode 210. In the substrate polishing process, due to the power supply source 400, each of the plurality of upper electrodes 300 may become a cathode, and the metal pattern W_M of the substrate W may become an anode.

When the metal pattern W_M of the substrate W is ionized with metal ions, the metal pattern W_M of the substrate W may be flattened. In detail, a portion of the metal pattern W_M of the substrate W that protrudes upward in the vertical direction (Z direction) may have a higher current density than other portions of the metal pattern W_M, and thus, ionization may proceed preferentially in the portion compared to the other portions. The ionized metal ions may be dissolved in the electrolyte 500 and removed.

For example, the closer a region of the metal pattern W_M of the substrate W is to the plurality of upper electrodes 300, the higher the current density in the region may become. The higher the current density in a portion of the metal pattern W_M of the substrate W, the more rapidly ionization of a metal material may occur in the portion. Accordingly, the metal pattern W_M of the substrate W may be removed so that the surface of the substrate W that faces the plurality of upper electrodes 300 becomes flat.

The plurality of edge upper electrodes 300_E may be located above the edge region of the substrate W to be polished, and the plurality of center upper electrodes 300_C may be located above the central region of the substrate W. A uniform electric field may be formed on the upper surface of the metal pattern W_M of the substrate W that is flattened by the plurality of upper electrodes 300. Accordingly, the polishing precision of the substrate polishing process performed on the upper surface of the metal pattern W_M of the substrate W may be improved.

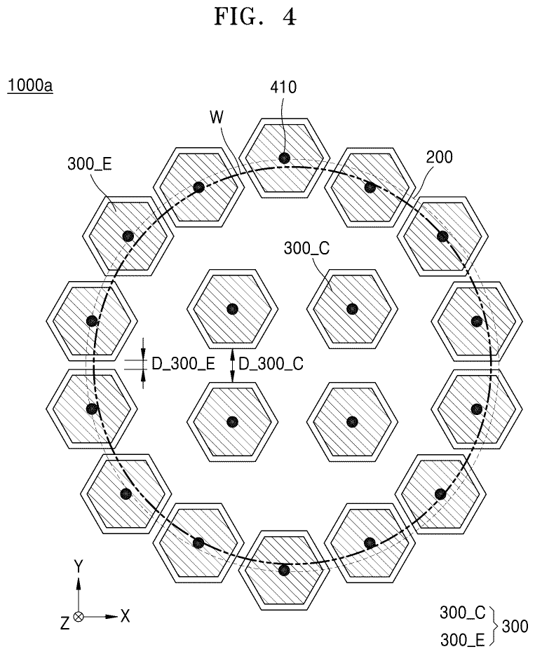

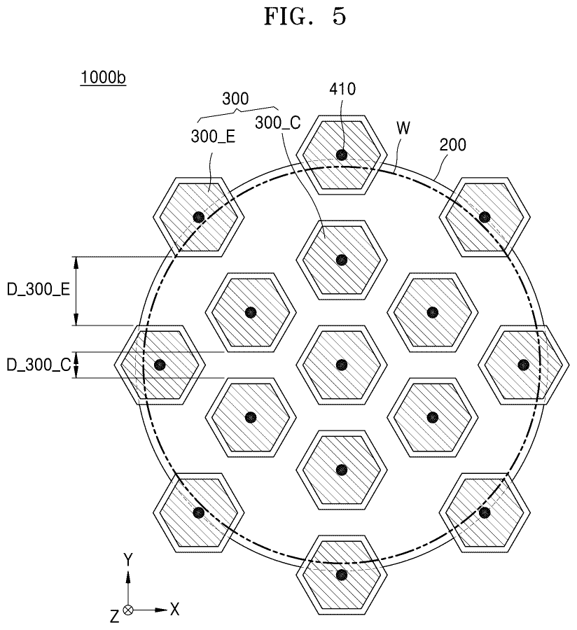

FIG. 4 is a schematic plan view of a substrate polishing apparatus 1000a according to some embodiments. FIG. 5 is a schematic plan view of a substrate polishing apparatus 1000b according to some embodiments.

Most of components and materials forming the substrate polishing apparatuses 1000a and 1000b described below are substantially the same as or similar to those described above with reference to FIG. 3. For convenience of description, the differences between the substrate polishing apparatuses 1000a and 1000b of FIGS. 4 and 5 and the substrate polishing apparatus 1000 of FIG. 3 described above will be mainly described.

For example, the substrate polishing apparatus 1000a of FIG. 4 and the substrate polishing apparatus 1000b of FIG. 5 each differ from the substrate polishing apparatus 1000 of FIG. 3 in the arrangement of the plurality of upper electrodes 300.

Referring to FIG. 4, the plurality of upper electrodes 300 of the substrate polishing apparatus 1000a may include the plurality of edge upper electrodes 300_E and the plurality of center upper electrodes 300_C. The plurality of edge upper electrodes 300_E may refer to upper electrodes that are located outermost among the plurality of upper electrodes 300, and the plurality of center upper electrodes 300_C may refer to upper electrodes that are located in a region surrounded by the plurality of edge upper electrodes 300_E, among the plurality of upper electrodes 300. For example, in a plan view, the plurality of edge upper electrodes 300_E may be located further outwardly than the plurality of center upper electrodes 300_C.

In a plan view, the plurality of upper electrodes 300 may be separated from one another in the horizontal direction. In some embodiments, the plurality of edge upper electrodes 300_E may be arranged at equal intervals, and the plurality of center upper electrodes 300_C may be arranged at equal intervals.

For example, a separation distance between the plurality of edge upper electrodes 300_E may be the first distance D_300_E. A separation distance between the plurality of center upper electrodes 300_C may be the second distance D_300_C. The first distance D_300_E and the second distance D_300_C may be different from one another. For example, the first distance D_300_E may be less than the second distance D_300_C. For example, the separation distance between the plurality of edge upper electrodes 300_E may be less than the separation distance between the plurality of center upper electrodes 300_C.

In the substrate polishing apparatus 1000a, the plurality of edge upper electrodes 300_E may be densely arranged, and thus, an electric field may be uniformly formed on an edge region of the upper surface of the substrate W. Accordingly, the polishing precision and polishing speed of the substrate W may be improved in the edge region of the substrate W.

Referring to FIG. 5, the plurality of upper electrodes 300 of the substrate polishing apparatus 1000b may include the plurality of edge upper electrodes 300_E and the plurality of center upper electrodes 300_C. The plurality of edge upper electrodes 300_E may protrude outwardly from the substrate W to be polished, and thus, the lower surface of each of the plurality of edge upper electrodes 300_E may overlap a side surface of the substrate W in the vertical direction (Z direction). The plurality of center upper electrodes 300_C may be located above the substrate W to be polished, and a lower surface of each of the plurality of center upper electrodes 300_C may overlap the upper surface of the substrate W in the vertical direction (Z direction).

In a plan view, the plurality of upper electrodes 300 may be separated from one another in the horizontal direction. In some embodiments, the plurality of edge upper electrodes 300_E may be arranged at equal intervals, and the plurality of center upper electrodes 300_C may be arranged at equal intervals. For example, a separation distance between the plurality of edge upper electrodes 300_E may be the first distance D_300_E. A separation distance between the plurality of center upper electrodes 300_C may be the second distance D_300_C that is less than the first distance D_300_E.

In the substrate polishing apparatus 1000b, the plurality of center upper electrodes 300_C may be densely arranged, and thus, an electric field may be uniformly formed on a central region of the upper surface of the substrate W. Accordingly, the polishing precision and polishing speed of the substrate W may be improved in the central region of the substrate W.

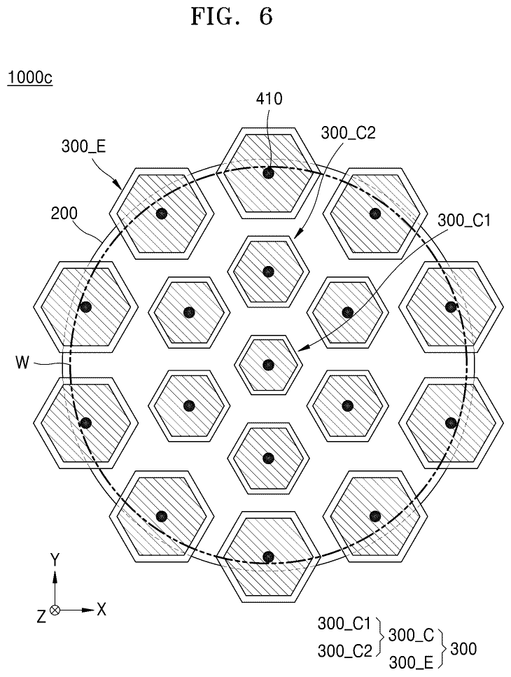

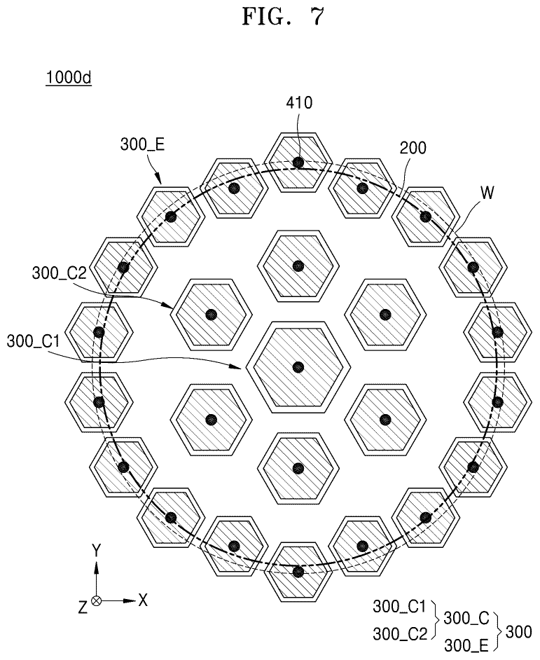

FIG. 6 is a schematic plan view of a substrate polishing apparatus 1000c according to some embodiments. FIG. 7 is a schematic plan view of a substrate polishing apparatus 1000d according to some embodiments.

Most of components and materials forming the substrate polishing apparatuses 1000c and 1000d described below are substantially the same as or similar to those described above with reference to FIG. 3. For convenience of description, the differences between the substrate polishing apparatuses 1000c and 1000d of FIGS. 6 and 7 and the substrate polishing apparatus 1000 of FIG. 3 described above will be mainly described.

For example, the substrate polishing apparatus 1000c of FIG. 6 and the substrate polishing apparatus 1000d of FIG. 7 each differ from the substrate polishing apparatus 1000 of FIG. 3 in the size of the plurality of upper electrodes 300.

Referring to FIG. 6, the plurality of upper electrodes 300 of the substrate polishing apparatus 1000c may include the plurality of edge upper electrodes 300_E and the plurality of center upper electrodes 300_C. The plurality of edge upper electrodes 300_E may be upper electrodes that are located outermost among the plurality of upper electrodes 300, and the plurality of center upper electrodes 300_C may be upper electrodes that are located in a region surrounded by the plurality of edge upper electrodes 300_E.

The width of each of the plurality of edge upper electrodes 300_E may be different from the width of each of the plurality of center upper electrodes 300_C. For example, the width of each of the plurality of edge upper electrodes 300_E may be greater than the width of each of the plurality of center upper electrodes 300_C. Herein, the width of an upper electrode indicates the length of the upper electrode in the horizontal direction. For example, an upper electrode having a relatively large width may have a relatively large lower surface area.

In some embodiments, when the plurality of upper electrodes 300 are arranged in a concentric pattern, the plurality of center upper electrodes 300_C may include a first center upper electrode 300_C1 and a second center upper electrode 300_C2. The first center upper electrode 300_C1 and the second center upper electrode 300_C2 may be located on different concentric circles. For example, the diameter of the circle on which the first center upper electrode 300_C1 is arranged may be less than the diameter of the circle on which the second center upper electrode 300_C2 is arranged.

For example, the width of the first center upper electrode 300_C1 may be less than the width of the second center upper electrode 300_C2. The area of a lower surface of the first center upper electrode 300_C1 may be less than the area of a lower surface of the second center upper electrode 300_C2. For example, the plurality of upper electrodes 300 may be arranged such that an upper electrode having a smaller width is located closer to the center of the upper surface of the substrate W.

By arranging an upper electrode having a small width in a region that requires precise polishing, the substrate polishing apparatus 1000c may have improved polishing precision. By reducing the number of upper electrodes required, the substrate polishing apparatus 1000c may have reduced equipment costs.

Referring to FIG. 7, the plurality of upper electrodes 300 of the substrate polishing apparatus 1000d may include the plurality of edge upper electrodes 300_E and the plurality of center upper electrodes 300_C. The plurality of edge upper electrodes 300_E may be upper electrodes that are located outermost among the plurality of upper electrodes 300, and the plurality of center upper electrodes 300_C may be upper electrodes that are located in a region surrounded by the plurality of edge upper electrodes 300_E.

The width of each of the plurality of edge upper electrodes 300_E may be different from the width of each of the plurality of center upper electrodes 300_C. For example, the area of the lower surface of each of the plurality of edge upper electrodes 300_E may be different from the area of the lower surface of each of the plurality of center upper electrodes 300_C. In some embodiments, the width of each of the plurality of edge upper electrodes 300_E may be less than the width of each of the plurality of center upper electrodes 300_C. The area of the lower surface of each of the plurality of edge upper electrodes 300_E may be less than the area of the lower surface of each of the plurality of center upper electrodes 300_C.

In some embodiments, when the plurality of upper electrodes 300 are arranged in a concentric pattern, the plurality of center upper electrodes 300_C may include the first center upper electrode 300_C1 and the second center upper electrode 300_C2. The first center upper electrode 300_C1 and the second center upper electrode 300_C2 may be located on different concentric circles. For example, the diameter of the circle on which the first center upper electrode 300_C1 is arranged may be less than the diameter of the circle on which the second center upper electrode 300_C2 is arranged.

For example, the width of the first center upper electrode 300_C1 may be greater than the width of the second center upper electrode 300_C2. The area of the lower surface of the first center upper electrode 300_C1 may be greater than the area of the lower surface of the second center upper electrode 300_C2. For example, the plurality of upper electrodes 300 may be arranged such that an upper electrode having a larger width is located closer to the center of the upper surface of the substrate W.

By arranging an upper electrode having a small width in a region that requires precise polishing, the substrate polishing apparatus 1000d may have improved polishing precision. By reducing the number of upper electrodes required, the substrate polishing apparatus 1000d may have reduced equipment costs.

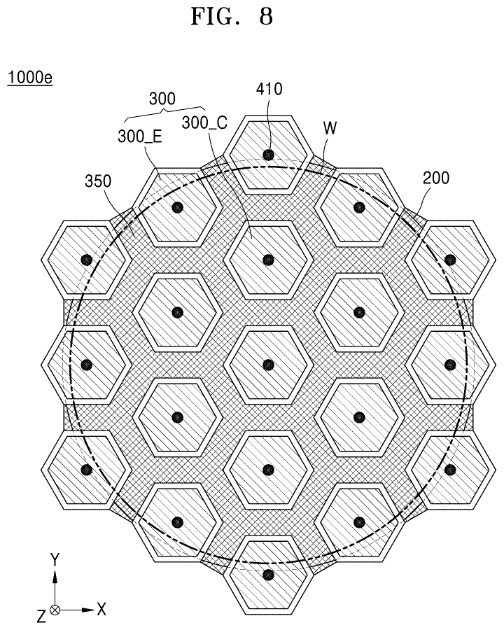

FIG. 8 is a schematic plan view of a substrate polishing apparatus 1000e according to some embodiments.

Most of components and materials forming the substrate polishing apparatus 1000e described below are substantially the same as or similar to those described above with reference to FIG. 3. For convenience of description, the differences between the substrate polishing apparatus 1000e of FIG. 8 and the substrate polishing apparatus 1000 of FIG. 3 described above will be mainly described.

For example, the substrate polishing apparatus 1000e of FIG. 8 differs from the substrate polishing apparatus 1000 of FIG. 3 with respect to a polymer layer 350.

Referring to FIG. 8, the substrate polishing apparatus 1000e may further include the polymer layer 350. The plurality of upper electrodes 300 may be separated from one another in the horizontal direction. A separation space may be defined between the plurality of upper electrodes 300. The polymer layer 350 may be located in the separation space between the plurality of upper electrodes 300. For example, the plurality of upper electrodes 300 may be separated from one another in the horizontal direction with the polymer layer 350 therebetween.

The polymer layer 350 may be in contact with the side surface of each of the plurality of upper electrodes 300. Collision between the plurality of upper electrodes 300 may be suppressed by the polymer layer 350. The durability of the plurality of upper electrodes 300 may be improved by the polymer layer 350.

In some embodiments, the length of the polymer layer 350 in the vertical direction (Z direction) may be equal to the length of each of the plurality of upper electrodes 300 in the vertical direction (Z direction). For example, an upper surface of the polymer layer 350 may be coplanar with the upper surface of each of the plurality of upper electrodes 300, and a lower surface of the polymer layer 350 may be coplanar with the lower surface of each of the plurality of upper electrodes 300.

In some embodiments, the polymer layer 350 may include a conductive material. For example, even when the polymer layer 350 includes a conductive material, because the core 301 (see FIG. 2) of each of the plurality of upper electrodes 300 is surrounded by the housing 302 (see FIG. 2), the plurality of upper electrodes 300 may not be electrically connected to one another due to the polymer layer 350. In addition, in some embodiments, the polymer layer 350 may include a non-conductive material.

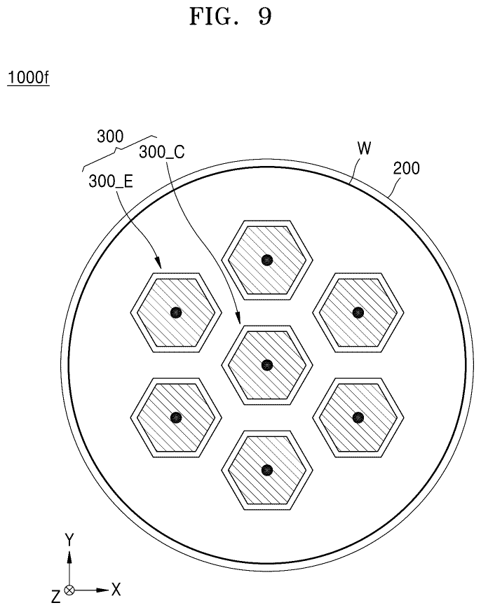

FIG. 9 is a schematic plan view of a substrate polishing apparatus 1000f according to some embodiments.

Most of components and materials forming the substrate polishing apparatus 1000f described below are substantially the same as or similar to those described above with reference to FIG. 3. For convenience of description, the differences between the substrate polishing apparatus 1000f of FIG. 9 and the substrate polishing apparatus 1000 of FIG. 3 described above will be mainly described.

For example, the substrate polishing apparatus 1000f of FIG. 9 differs from the substrate polishing apparatus 1000 of FIG. 3 in the arrangement of the plurality of edge upper electrodes 300_E.

Referring to FIG. 9, the plurality of upper electrodes 300 of the substrate polishing apparatus 1000f may include the plurality of edge upper electrodes 300_E and the center upper electrode 300_C. Although FIG. 9 shows one center upper electrode 300_C, the number of center upper electrodes 300_C may be two or more.

In a plan view, the plurality of edge upper electrodes 300_E may refer to upper electrodes that are located outermost among the plurality of upper electrodes 300. The plurality of edge upper electrodes 300_E may not protrude outwardly from the substrate support 200. For example, a side surface of each of the plurality of edge upper electrodes 300_E may overlap the upper surface of the substrate support 200 in the vertical direction (Z direction). For example, the entire lower surfaces of the plurality of edge upper electrodes 300_E may face the upper surface of the substrate support 200.

In some embodiments, the plurality of edge upper electrodes 300_E may not protrude outwardly from the upper surface of the substrate W. For example, the plurality of edge upper electrodes 300_E may be adjacent to the edge of the upper surface of the substrate W, rather than the center of the upper surface of the substrate W, but may not protrude outwardly from the substrate W. For example, the side surface of each of the plurality of edge upper electrodes 300_E may overlap the upper surface of the substrate W in the vertical direction (Z direction). By forming a uniform electric field on the upper surface of the substrate W and optimizing the number of upper electrodes 300 required, the substrate polishing apparatus 1000f may have reduced costs.

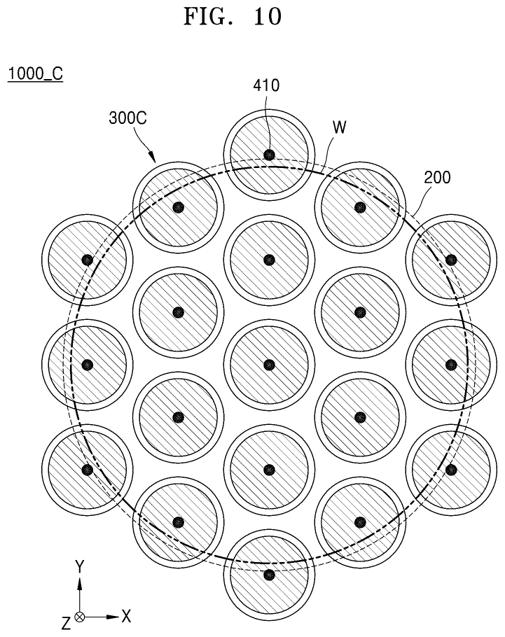

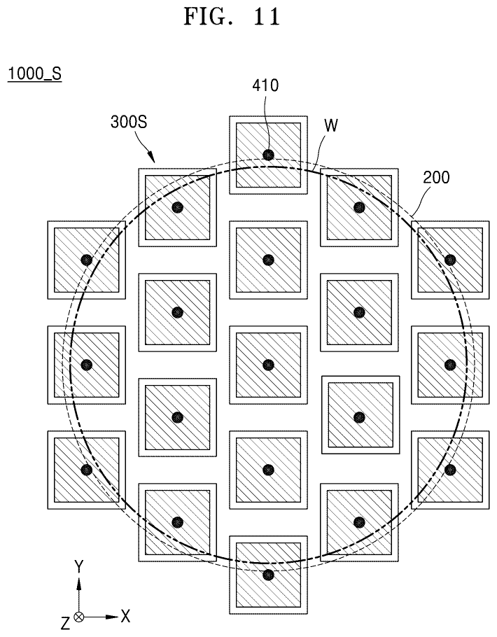

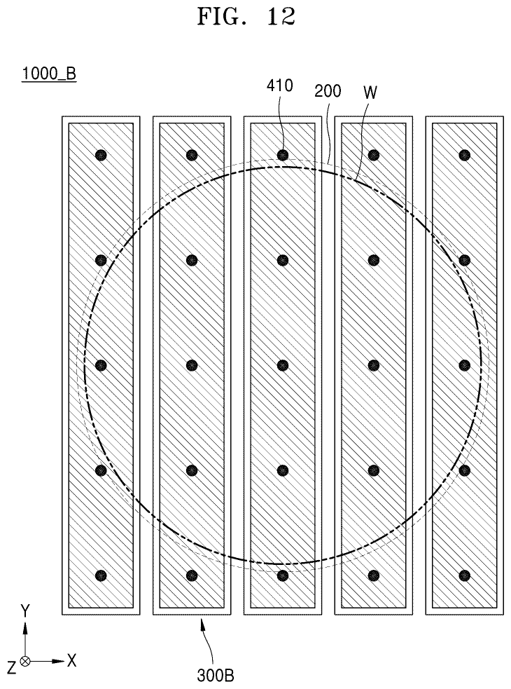

FIG. 10 is a schematic plan view of a substrate polishing apparatus 1000_C according to some embodiments. FIG. 11 is a schematic plan view of a substrate polishing apparatus 1000_S according to some embodiments. FIG. 12 is a schematic plan view of a substrate polishing apparatus 1000_B according to some embodiments.

Most of components and materials forming the substrate polishing apparatuses 1000_C, 1000_S, and 1000_B described below are substantially the same as or similar to those described above with reference to FIG. 3. For convenience of description, the differences between the substrate polishing apparatuses 1000_C, 1000_S, and 1000_B of FIGS. 10 to 12 and the substrate polishing apparatus 1000 of FIG. 3 described above will be mainly described.

For example, the substrate polishing apparatus 1000_C of FIG. 10, the substrate polishing apparatus 1000_S of FIG. 11, and the substrate polishing apparatus 1000_B of FIG. 12 each differ from the substrate polishing apparatus 1000 of FIG. 3 in the shape of the plurality of upper electrodes 300.

Referring to FIG. 10, a lower surface of each of a plurality of upper electrodes 300C of the substrate polishing apparatus 1000_C may have a circular shape. For example, the plurality of upper electrodes 300C may each have a cylindrical shape. For example, a horizontal cross-section of each of the plurality of upper electrodes 300C may have a circular shape. The diameter of each of the plurality of upper electrodes 300C may be less than the diameter of the substrate W.

Referring to FIG. 11, a lower surface of each of a plurality of upper electrodes 300S of the substrate polishing apparatus 1000_S may have a quadrangular shape. However, embodiments are not limited thereto, and the lower surface of each of the plurality of upper electrodes 300S may have a polygonal shape, such as a triangular shape. For example, the plurality of upper electrodes 300S may each have a quadrangular prism shape. For example, a horizontal cross-section of each of the plurality of upper electrodes 300S may have a polygonal shape. The width of each of the plurality of upper electrodes 300S may be less than the diameter of the substrate W.

Referring to FIG. 12, a lower surface of each of a plurality of upper electrodes 300_B of the substrate polishing apparatus 1000_B may have a rectangular shape of which the length in the second horizontal direction (Y direction) is greater than the diameter of the substrate W. For example, the lower surface of each of the plurality of upper electrodes 300_B may have a bar shape of which the length in the second horizontal direction (Y direction) is greater than the length in the first horizontal direction (X direction).

For example, the plurality of upper electrodes 300_B may be separated from one another in the first horizontal direction (X direction). For example, at least a portion of each of the plurality of upper electrodes 300_B may protrude outwardly from the substrate W.

In some embodiments, a plurality of wires 410 may be connected to each of the plurality of upper electrodes 300_B. The wires 410 connected to one of the plurality of upper electrodes 300_B may be arranged in a line in the second horizontal direction (Y direction). By connecting the plurality of wires 410 to one upper electrode, a voltage difference occurring in the one upper electrode may be reduced. Accordingly, a uniform electric field may be formed above the substrate W, thereby improving polishing precision.

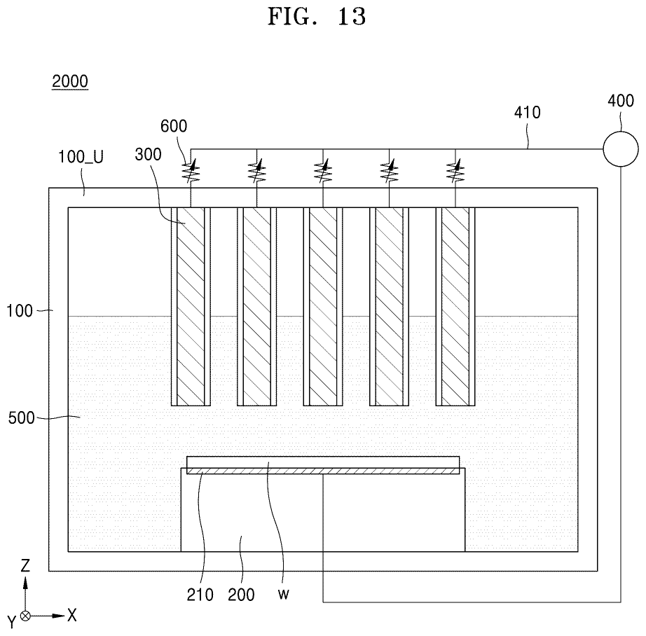

FIG. 13 is a schematic cross-sectional view of a substrate polishing apparatus 2000 according to some embodiments.

Most of components and materials forming the substrate polishing apparatus 2000 described below are substantially the same as or similar to those described above with reference to FIG. 1. For convenience of description, the differences between the substrate polishing apparatus 2000 of FIG. 13 and the substrate polishing apparatus 1000 of FIG. 1 described above will be mainly described.

Referring to FIG. 13, the substrate polishing apparatus 2000 may include the process chamber 100, the substrate support 200, the plurality of upper electrodes 300, the lower electrode 210, a plurality of variable resistors 600, and the power supply source 400.

The plurality of variable resistors 600 may be connected to the plurality of upper electrodes 300. For example, the plurality of variable resistors 600 may be respectively connected in correspondence to the plurality of upper electrodes 300. For example, the plurality of variable resistors 600 may be configured such that resistance values thereof are adjustable. For example, the plurality of variable resistors 600 may correspond to the plurality of upper electrodes 300 on a one-to-one basis.

The plurality of upper electrodes 300 may be connected in parallel to one another to the power supply source 400. The plurality of variable resistors 600 may be respectively connected to the plurality of upper electrodes 300, and may be connected in parallel to one another to the power supply source 400. Due to the plurality of variable resistors 600, resistance values between the plurality of upper electrodes 300 and the power supply source 400 may vary for each of the plurality of upper electrodes 300.

In some embodiments, the wire 410 connecting the power supply source 400 to the plurality of upper electrodes 300 may be branched such that the plurality of upper electrodes 300 are connected in parallel to the power supply source 400. For example, the plurality of variable resistors 600 may be installed in the branched portions of the wire 410.

By adjusting the resistance value of each of the plurality of variable resistors 600, the amount of current flowing from the power supply source 400 to each of the plurality of upper electrodes 300 may be adjusted. By adjusting the amount of current flowing through each of the plurality of upper electrodes 300 according to an uneven pattern of the upper surface of the substrate W to be polished, the substrate polishing speed may be adjusted for each region of the upper surface of the substrate W. Accordingly, the substrate polishing apparatus 2000 may have improved substrate polishing precision.

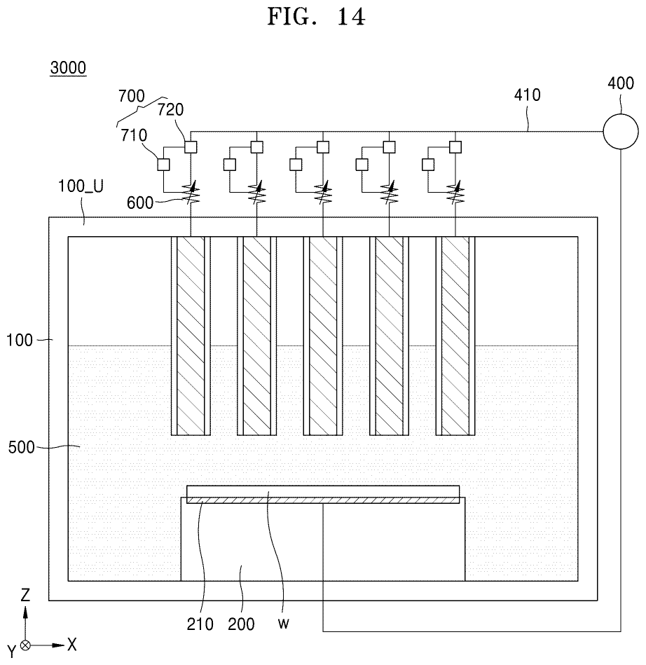

FIG. 14 is a schematic cross-sectional view of a substrate polishing apparatus 3000 according to some embodiments.

Most of components and materials forming the substrate polishing apparatus 3000 described below are substantially the same as or similar to those described above with reference to FIG. 13. For convenience of description, the differences between the substrate polishing apparatus 3000 of FIG. 14 and the substrate polishing apparatus 2000 of FIG. 13 described above will be mainly described.

Referring to FIG. 14, the substrate polishing apparatus 3000 may include the process chamber 100, the substrate support 200, the plurality of upper electrodes 300, the lower electrode 210, the plurality of variable resistors 600, a plurality of feedback units 700, and the power supply source 400.

The plurality of feedback units 700 may be respectively and electrically connected to the plurality of upper electrodes 300 and the plurality of variable resistors 600. The plurality of feedback units 700 may correspond to the plurality of variable resistors 600. For example, the number of feedback units 700, the number of variable resistors 600, and the number of upper electrodes 300 may be the same. For example, a first upper electrode, which is one of the plurality of upper electrodes 300, may be electrically connected to a first variable resistor and a first feedback unit.

Each of the plurality of upper electrodes 300, the plurality of variable resistors 600, and the plurality of feedback units 700 may be connected in parallel to the power supply source 400. For example, the wire 410 connecting the power supply source 400 to the plurality of upper electrodes 300 may be branched such that the plurality of upper electrodes 300 are connected in parallel to the power supply source 400. The plurality of feedback units 700 and the plurality of variable resistors 600 may be installed in the branched portions of the wire 410.

Each of the plurality of feedback units 700 may measure the amount of current flowing to the upper electrode 300 connected thereto, and may adjust, based on a measured value, the resistance value of the variable resistor 600 connected thereto. For example, when the first upper electrode, the first variable resistor, and the first feedback unit are connected in series to the power supply source 400, the first feedback unit may measure the amount of current flowing to the first upper electrode, and may adjust the resistance value of the first variable resistor.

Each of the plurality of feedback units 700 may include an ammeter 720 and a controller 710. The ammeter 720 of each of the plurality of feedback units 700 may be connected in series to each of the plurality of upper electrodes 300. The controller 710 of each of the plurality of feedback units 700 may be connected to the ammeter 720 of each of the plurality of feedback units 700 and each of the plurality of variable resistors 600.

The ammeter 720 of each of the plurality of feedback units 700 may measure the amount of current flowing to the upper electrode 300 to which each of the plurality of feedback units 700 is connected. The controller 710 of each of the plurality of feedback units 700 may adjust the resistance value of the variable resistor 600 connected thereto, based on a value measured by the ammeter 720 connected thereto. In some embodiments, the ammeter 720 of each of the plurality of feedback units 700 may be a voltammeter.

For example, the amount of current flowing to each of the plurality of upper electrodes 300 may vary depending on the distance between each of the plurality of upper electrodes 300 and the upper surface of the substrate W to be polished. For example, the amount of current flowing to the upper electrode 300 located above a significantly protruding portion of the metal pattern W_M (see FIG. 2) of the substrate W may be greater than the amount of current flowing to the upper electrode 300 located above a significantly recessed portion of the metal pattern W_M of the substrate W.

For example, as the amount of current flowing to each of the plurality of upper electrodes 300 decreases, the strength of an electric field formed by each of the plurality of upper electrodes 300 may decrease, and thus, the substrate polishing speed may decrease. For example, by individually adjusting the amount of current flowing to each of the plurality of upper electrodes 300, the substrate polishing speed may be adjusted for each portion of the upper surface of the substrate W.

Each of the plurality of feedback units 700 may be connected in series to each of the plurality of upper electrodes 300, may measure the amount of current flowing to each of the plurality of upper electrodes 300, and may measure the resistance value of each of the plurality of variable resistors 600 to adjust the amount of current flowing to each of the plurality of upper electrodes 300. In some embodiments, the substrate polishing apparatus 3000 may measure a changes in the amount of current flowing to each of the plurality of upper electrodes 300 to calculate the degree of unevenness of the upper surface of the substrate W. Thereafter, based on the degree of unevenness of the upper surface of the substrate W, the amount of current flowing to each of the plurality of upper electrodes 300 may be adjusted such that the upper surface of the substrate W becomes flat.

The substrate polishing apparatus 3000 may measure the degree of curvature of the upper surface of the substrate W through the amount of current flowing through each of the plurality of upper electrodes 300, and may control the polishing speed of each of the plurality of upper electrodes 300 according to the degree of curvature of the upper surface of the substrate W. Accordingly, the substrate polishing apparatus 3000 may have not only improved substrate polishing precision, but also improved substrate polishing speed.

A substrate polishing method will be described with reference to FIG. 14.

The substrate polishing method may include mounting the substrate W on the substrate support 200 in the process chamber 100, applying, by the power supply source 400, voltages to the plurality of upper electrodes 300 and the lower electrode 210, and taking the substrate W that has been polished out of the process chamber 100.

The substrate W may be brought into or taken out of the process chamber 100 in a state where the processing space of the process chamber 100 is filled with the electrolyte 500. However, embodiments are not limited thereto, and the substrate W may be brought into or taken out of the process chamber 100 in a state where no electrolyte is present in the processing space of the process chamber 100.

In some embodiments, in the applying, by the power supply source 400, of the voltages to the plurality of upper electrodes 300 and the lower electrode 210, the feedback unit 700 connected in series to each of the plurality of upper electrodes 300 may adjust the amount of current flowing to each of the plurality of upper electrodes 300.

For example, each of the plurality of feedback units 700 may measure, through the ammeter 720, the amount of current flowing to each of the plurality of upper electrodes 300 when the resistance value of each of the plurality of variable resistors 600 is equal to a reference value, to determine the degree of curvature of the upper surface of the substrate W mounted on the substrate support 200.

Thereafter, each of the plurality of feedback units 700 may increase, through the controller 710, the amount of current flowing to the upper electrode 300 located above a relatively significantly curved portion of the upper surface of the substrate W, thereby removing the curved portion of the upper surface of the substrate W so that the upper surface of the substrate W becomes flat.

In some embodiments, in the applying, by the power supply source 400, of the voltages to the plurality of upper electrodes 300 and the lower electrode 210, the amount of current flowing to each of the plurality of upper electrodes 300 may vary depending on a separation distance from the upper surface of the substrate W. By measuring a change in the amount of current flowing to each of the plurality of upper electrodes 300, the substrate polishing speed may be adjusted.

Thereafter, when the resistance value of each of the plurality of variable resistors 600 is equal to the reference value, the amount of current applied to each of the plurality of upper electrodes 300 may be calculated to determine whether the polishing of the metal pattern W_M (see FIG. 2) of the substrate W is complete. When it is determined that polishing of the substrate W is complete, the substrate W may be taken out of the process chamber 100.

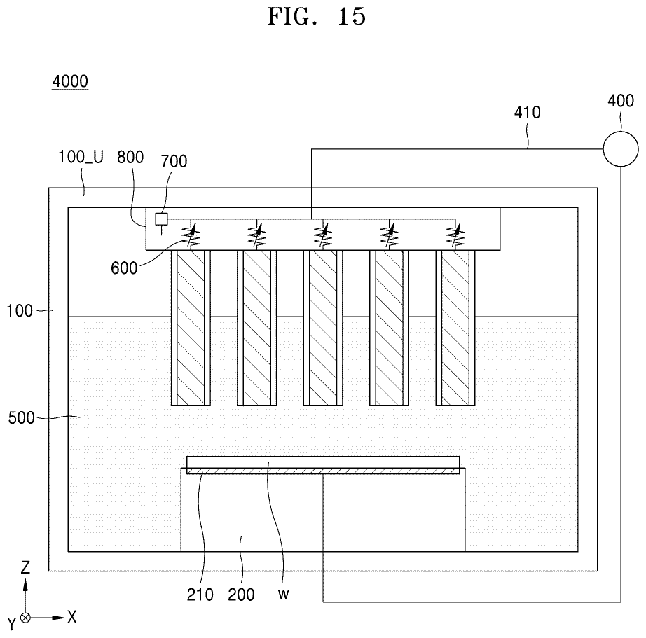

FIG. 15 is a schematic cross-sectional view of a substrate polishing apparatus 4000 according to some embodiments.

Most of components and materials forming the substrate polishing apparatus 4000 described below are substantially the same as or similar to those described above with reference to FIG. 13. For convenience of description, the differences between the substrate polishing apparatus 4000 of FIG. 15 and the substrate polishing apparatus 2000 of FIG. 13 described above will be mainly described.

Referring to FIG. 15, the substrate polishing apparatus 4000 may include the process chamber 100, the substrate support 200, an upper plate 800, the plurality of upper electrodes 300, the lower electrode 210, the plurality of variable resistors 600, the plurality of feedback units 700, and the power supply source 400.

The upper plate 800 may be located on the ceiling 100_U of the process chamber 100. The upper plate 800 may form a single body with the ceiling 100_U of the process chamber 100. The plurality of upper electrodes 300 may be detachably coupled to the upper plate 800. For example, the plurality of upper electrodes 300 may be connected to a lower surface of the upper plate 800.

In some embodiments, the plurality of upper electrodes 300 may include pins configured to be received in sockets of the upper plate 800. The plurality of upper electrodes 300 may be coupled to the upper plate 800 in a pin-socket manner. In some embodiments, the plurality of upper electrodes 300 may be physically coupled to the upper plate 800 so as to be detachable by clamps of the upper plate 800. In some embodiments, the plurality of upper electrodes 300 may include screw threads, and the upper plate 800 may include grooves into which the screw threads of the plurality of upper electrodes 300 are received. The plurality of upper electrodes 300 may be detachably coupled to the upper plate 800 in a screw manner.

Because the plurality of upper electrodes 300 may be attached to and detached from the upper plate 800, the substrate polishing apparatus 4000 may be easily maintained. In addition, the shape and size of the plurality of upper electrodes 300 may be changed according to the state of the substrate W to be polished, and thus, substrate polishing efficiency may be improved. In addition, a separation distance between the plurality of upper electrodes 300 may be adjusted differently according to the state of the substrate W to be polished.

In some embodiments, the plurality of feedback units 700 and the plurality of variable resistors 600 may be installed inside the upper plate 800. The power supply source 400 may be electrically connected to the plurality of upper electrodes 300 through the upper plate 800.

While the disclosed concepts have been particularly shown and described with reference to embodiments thereof, it will be understood that various changes in form and details may be made therein without departing from the spirit and scope of the following claims.

What is claimed is:

1. A substrate polishing apparatus comprising:
a process chamber providing a processing space;
a substrate support located in the processing space of the process chamber and configured such that a substrate is mounted thereon;
a lower electrode located on the substrate support and located below the substrate;
a plurality of upper electrodes located in the processing space, separated from the substrate support, located above the substrate support, and separated from one another in a substantially horizontal direction; and
a power supply source configured to apply voltages to the plurality of upper electrodes and the lower electrode,
wherein the plurality of upper electrodes include a plurality of edge upper electrodes and a plurality of center upper electrodes, the plurality of edge upper electrodes being located outermost among the plurality of upper electrodes in a plan view, and the plurality of center upper electrodes being located in a region surrounded by the plurality of edge upper electrodes,
a width of each of the plurality of upper electrodes is less than a width of the lower electrode, and
a portion of each of the plurality of edge upper electrodes protrudes outwardly from the substrate support in the plan view.

2. The substrate polishing apparatus of claim 1, wherein the power supply source is further configured to apply a voltage to each of the lower electrode and the plurality of upper electrodes such that the substrate to be polished becomes an anode and the plurality of upper electrodes become cathodes.

3. The substrate polishing apparatus of claim 2, further comprising an electrolyte filling the processing space of the process chamber and acting as a medium between the substrate and the plurality of upper electrodes, wherein:
the substrate mounted on the substrate support is located inside the electrolyte, and
a lower surface of each of the plurality of upper electrodes is located inside the electrolyte.

4. The substrate polishing apparatus of claim 1, wherein:
each of the plurality of upper electrodes includes a core and a housing, the core including a conductive material, and
the housing surrounding a side surface of the core.

5. The substrate polishing apparatus of claim 1, wherein an air gap is located between the plurality of upper electrodes.

6. The substrate polishing apparatus of claim 1, further comprising a polymer layer located in a separation space between the plurality of upper electrodes.

7. The substrate polishing apparatus of claim 1, wherein a width of each of the plurality of edge upper electrodes is different from a width of each of the plurality of center upper electrodes.

8. The substrate polishing apparatus of claim 7, wherein the width of each of the plurality of edge upper electrodes is less than the width of each of the plurality of center upper electrodes.

9. The substrate polishing apparatus of claim 1, wherein a separation distance between the plurality of edge upper electrodes is different from a separation distance between the plurality of center upper electrodes.

10. The substrate polishing apparatus of claim 9, wherein the separation distance between the plurality of edge upper electrodes is less than the separation distance between the plurality of center upper electrodes.

11. The substrate polishing apparatus of claim 1, further comprising an upper plate configured such that the plurality of upper electrodes are detachably coupled thereto,
wherein the plurality of upper electrodes are electrically connected to the power supply source through the upper plate.

12. The substrate polishing apparatus of claim 1, further comprising a plurality of variable resistors respectively connected to the plurality of upper electrodes and configured to adjust an intensity of the voltage applied to the plurality of upper electrodes.

13. A substrate polishing apparatus comprising:
a process chamber providing a processing space;
a substrate support located in the processing space of the process chamber and configured such that a substrate is mounted thereon;
a lower electrode located on the substrate support and located below the substrate;
a plurality of upper electrodes located in the processing space, separated from the substrate support, located above the substrate support, and separated from one another in a substantially horizontal direction;
an electrolyte located in the processing space of the process chamber and located between the plurality of upper electrodes and the lower electrode;
a power supply source configured to apply voltages to the plurality of upper electrodes and the lower electrode; and
a plurality of variable resistors respectively connected to the plurality of upper electrodes.

14. The substrate polishing apparatus of claim 13, further comprising a plurality of ammeters respectively connected to the plurality of upper electrodes and configured to measure amounts of current flowing to the respective plurality of upper electrodes.

15. The substrate polishing apparatus of claim 14, further comprising a plurality of controllers respectively connected to the plurality of ammeters and the plurality of variable resistors and configured to adjust resistance values of the respective plurality of variable resistors, based on values measured by the respective plurality of ammeters.

16. The substrate polishing apparatus of claim 13, wherein the electrolyte is in a liquid state and includes phosphoric acid.

17. The substrate polishing apparatus of claim 13, wherein:
the plurality of upper electrodes include a plurality of edge upper electrodes and a plurality of center upper electrodes, the plurality of edge upper electrodes being located outermost among the plurality of upper electrodes in a plan view, and the plurality of center upper electrodes being located in a region surrounded by the plurality of edge upper electrodes, and
lower surfaces of the plurality of edge upper electrodes overlap a side surface of the substrate support in a substantially vertical direction.

18. The substrate polishing apparatus of claim 17, wherein:
a width of each of the plurality of edge upper electrodes is less than a width of each of the plurality of center upper electrodes, and
a separation distance between the plurality of edge upper electrodes is less than a separation distance between the plurality of center upper electrodes.

19. A substrate polishing apparatus comprising:
a process chamber providing a processing space;
a substrate support located in the processing space of the process chamber and configured such that a substrate is mounted thereon;
a lower electrode located on the substrate support and located below the substrate;
a plurality of upper electrodes located in the processing space, separated from the substrate support, located above the substrate support, and separated from one another in a substantially horizontal direction;
a power supply source configured to apply voltages to the plurality of upper electrodes and the lower electrode;
a plurality of variable resistors respectively connected to the plurality of upper electrodes; and
a plurality of feedback units respectively connected to the plurality of upper electrodes and the plurality of variable resistors and configured to measure amounts of current flowing to the respective plurality of upper electrodes and adjust resistance values of the respective plurality of variable resistors, wherein:
the plurality of upper electrodes include a plurality of edge upper electrodes and a plurality of center upper electrodes, the plurality of edge upper electrodes being located outermost among the plurality of upper electrodes in a plan view, and the plurality of center upper electrodes being located in a region surrounded by the plurality of edge upper electrodes,
a width of each of the plurality of upper electrodes is less than a width of the lower electrode, and
lower surfaces of the plurality of edge upper electrodes overlap a side surface of the substrate support in a substantially vertical direction.

20. The substrate polishing apparatus of claim 19, further comprising an electrolyte in a liquid state, located in the processing space of the process chamber, and located between the plurality of upper electrodes and the lower electrode, wherein:
a width of each of the plurality of edge upper electrodes is different from a width of each of the plurality of center upper electrodes, and
a separation distance between the plurality of edge upper electrodes is different from a separation distance between the plurality of center upper electrodes.
